(19) United States
(12) Patent Application Publication
(10) Pub. No.: US 2014/0244722 A1
(43) Pub. Date: Aug. 28, 2014

(54) INFORMATION SHARING SYSTEM

(71) Applicant: NINTENDO CO., LTD., Kyoto (JP)

(72) Inventor: Yugo HAYASHI, Kyoto (JP)

(73) Assignee: NINTENDO CO., LTD., Kyoto (JP)

(21) Appl. No.: 13/973,277

(22) Filed: Aug. 22, 2013

(30) Foreign Application Priority Data
Feb. 27, 2013 (JP) 2013-37004

(51) Int. Cl. H04L 29/06

(52) U.S. Cl. CPC H04L 29/06047
USPC 709/203

(57) ABSTRACT

An example information-processing device includes: a sending unit that sends data dependent on an application as shared information, the shared information being associated with a community to which a user of the information-processing device belongs from among one or more communities relevant to the application; a receiving unit that receives shared information sent from another user, who belongs to the community to which the user of the information-processing device belongs; and an outputting unit that outputs information generated based on the shared information received by the receiving unit.

### CROSS REFERENCE TO RELATED APPLICATIONS

This application is based on and claims priorities under 35 USC 119 from Japanese patent application No. 2013-37004, which was filed on Feb. 27, 2013.

### FIELD

The technique described herein relates to sharing information between users.

### BACKGROUND AND SUMMARY

A home video game machine is known in which a user is able to register a friend or a family member as a “friend” using a communication capability, and to view a performance in a game of the “friend.”

There is provided an information-processing device, including: a sending unit that sends data dependent on an application as shared information, the shared information being associated with a community to which a user of the information-processing device belongs from among one or more communities relevant to the application; a receiving unit that receives shared information sent from another user, who belongs to the community to which the user of the information-processing device belongs; and an outputting unit that outputs information generated based on the shared information received by the receiving unit.

### BRIEF DESCRIPTION OF THE DRAWINGS

FIG. 1 shows an example of a non-limiting configuration of an information sharing system.

FIG. 2 shows an example of a non-limiting hardware configuration of a terminal device.

FIG. 3 shows an example of a non-limiting hardware configuration of a main device.

FIG. 4 shows an example of a non-limiting hardware configuration of a server device.

FIG. 5 shows an example of a non-limiting functional configuration of a main device.

FIG. 6 is an example of a non-limiting sequence chart showing operations of a main device and a server device.

FIG. 7 shows an example of a non-limiting screen (menu screen) displayed at a terminal device or a display device.

FIG. 8 shows an example of a non-limiting screen (user-detail screen) displayed at a terminal device or a display device.

FIG. 9 shows an example of a non-limiting screen (community-detail screen) displayed at a terminal device or a display device.

### DETAILED DESCRIPTION OF NON-LIMITING EXEMPLARY EMBODIMENTS

### Exemplary Embodiment

### (1) Configuration

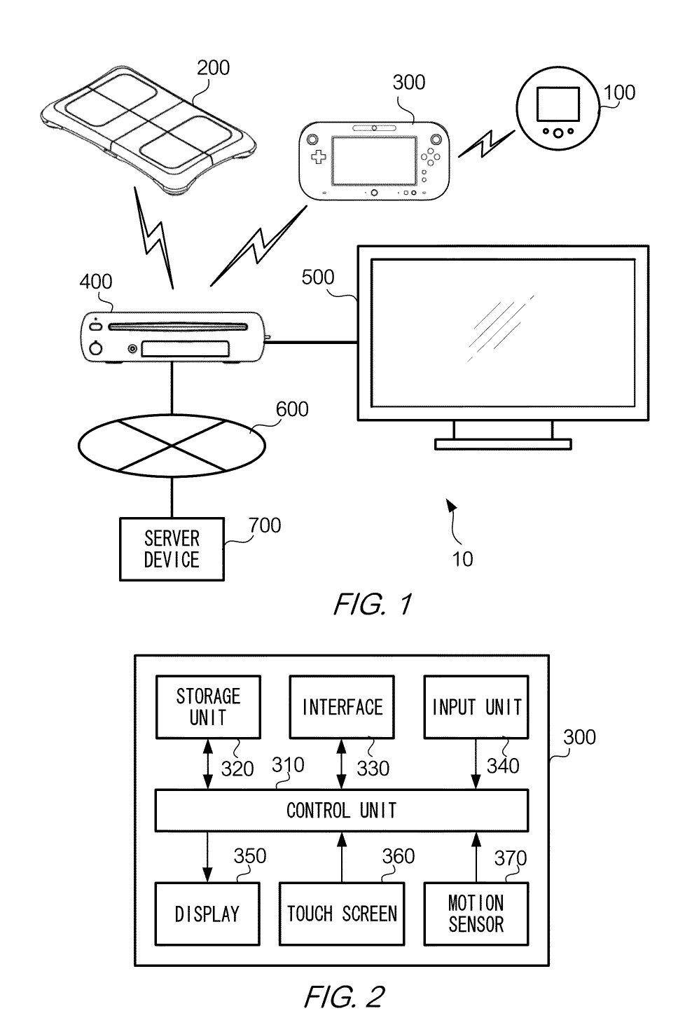

FIG. 1 is a diagram showing a configuration of information sharing system 10, which is an exemplary embodiment according to the present technique. Information sharing system 10 is an information processing system for measuring an amount of a physical activity, such as playing a game, for each user, and for assisting communication between users. Information sharing system 10 includes activity meter 100, load input device 200, terminal device 300, main device 400, display device 500, network 600, and server device 700. Activity meter 100, load input device 200, terminal device 300, main device 400, and display device 500 are owned by each user.

A physical activity is a general activity involving a user's body, which consumes energy. A physical activity is not limited to an exercise (an activity which is purposefully or intentionally performed to maintain or improve body strength). A physical activity may include walking, using stairs, and housework. An amount of a physical activity is a quantitative representation of a physical activity. In the present exemplary embodiment, an amount of a physical activity is expressed in calories (cal). In the present exemplary embodiment, the MET(s) (Metabolic Equivalent Task) is used as a unit of exercise intensity. A physical activity is qualified using the MET. A value of exercise intensity equal to or more than “1.0” is pre-assigned to each physical activity to be measured. A value of exercise intensity at rest is “1.0.”

In the present exemplary embodiment, a number of calories burned (a caloric expenditure) through a physical activity by a user is obtained by multiplying an exercise intensity of the physical activity by a weight of the user, an exercise time, and a value “1.05.” Accordingly, a caloric expenditure varies depending on a weight of a user. A caloric expenditure may vary from one user to another if a physical activity having the same exercise intensity is performed by users for the same length of time. A caloric expenditure may be calculated using another method.

Activity meter 100 is a portable measuring instrument that measures an amount of physical activity of a user. Activity meter 100 includes an acceleration sensor and an altitude sensor (pneumatic sensor), and sends measurement data indicative of an amount of physical activity of a user to terminal device 300. In the present exemplary embodiment, activity meter 100 sends measurement data to terminal device 300 via infrared communication. However, another wireless communication system may be employed. Alternatively, activity meter 100 may be physically connected to terminal device 300 via an interface such as a USB (Universal Serial Bus) interface. Activity meter 100 may include a display for displaying an amount of physical activity or information generated based on the amount of physical activity.

Measurement data provided by activity meter 100 is data indicative of an amount of physical activity per unit time (for example, on a minute-by-minute basis). In the present exemplary embodiment, measurement data includes data on a number of steps measured by activity meter 100, and data on a time series variation of altitude, physical activity, and exercise intensity. Physical activities that can be measured by activity meter 100 are pre-classified into categories such as “walking,” “using stairs,” “brisk walking,” and “jogging,” and ID (identification data) of a corresponding category is pre-assigned to each physical activity. Activity meter 100 identifies a category of each physical activity based on measured changes in acceleration and altitude. ID of each category is associated with an exercise intensity of a corresponding physical activity.

Data on an amount of physical activity is not limited to the above-mentioned data, and may be another form of data, based on which an amount of physical activity can be identified. Data on an amount of physical activity may be data directly indicating an amount of physical activity, or data that can be used by other devices to calculate an amount of physical activity. For example, activity meter 100 may calculate an amount of physical activity based on values output from sensors such as an acceleration sensor, and output data on the calculated amount of physical activity as measurement data. Alternatively, activity meter 100 may output data on values output from sensors such as an acceleration sensor as measurement data, and main device 400 (or terminal device 300) may calculate an amount of physical activity based on the measurement data.

Load input device 200 is an input device for inputting a load. Load input device 200 includes a planar portion on which a user is able to place a part of his/her body (hands, feet, or a bottom), and measures a load applied to the planar part using a load sensor such as a strain gauge. Plural load sensors may be arranged at different positions in the planar part to detect which side (front or back, or left or right) of the planar part a load is applied to. Load input device 200 sends load data indicative of a load measured by the load sensor to main device 400. In the present exemplary embodiment, load input device 200 sends load data to main device 400 via Bluetooth™; however, any other communication system may be employed, as in the case of activity meter 100.

In the present exemplary embodiment, load input device 200 serves as a means for measuring a body weight (a weight scale), and also serves as a means for assisting measurement of an amount of a physical activity using a management program (described later). Load input device 200 sends load data as data for determining whether physical activities are properly performed in accordance with the management program.

Terminal device 300 is a terminal device that receives an input operation from a user, and displays an image. Terminal device 300 is, in other words, a portable display device. A user holds and operates terminal device 300 by pressing buttons provided on the device, or by tilting the device.

FIG. 2 is a block diagram showing a hardware configuration of terminal device 300. Terminal device 300 includes control unit 310, storage unit 320, interface 330, input unit 340, display 350, touch screen 360, and motion sensor 370.

Control unit 310 controls operations of components of terminal device 300. Specifically, control unit 310 includes a processor such as a CPU (Central Processing Unit) and a memory, and executes programs to carry out a variety of processing.

Storage unit 320 stores data. Specifically, storage unit 320 includes a storage medium such as a flash memory, and stores data for processing by control unit 310.

Interface 330 exchanges data with activity meter 100 and main device 400. Specifically, interface 330 exchanges data with activity meter 100 using a predetermined communication system such as infrared communication. Interface 330 also includes an antenna and a modem, and communicates with main device 400 using a predetermined communication system. For example, interface 330 communicates with main device 400 via a wireless LAN (Local Area Network).

Input unit 340 receives an input operation from a user. Input unit 340 includes buttons and an analog joystick, and provides input operation data indicative of an input operation from a user to control unit 310.

Display 350 displays an image. Display 350 includes a display panel composed of liquid crystal elements or organic EL (Electroluminescence) elements, and a drive circuit for driving the display panel. Display 350 displays an image based on display data.

Touch screen 360 receives an input operation to a screen performed by a user. Touch screen 360 includes a sensor arranged over the display panel of display 350, and provides coordinate data indicative of a position (a coordinate) indicated by a user to control unit 310. A user indicates a position on a screen using his/her finger or a touch-pen (stylus).

Motion sensor 370 outputs data indicative of a motion of terminal device 300. Motion sensor 370 includes an acceleration sensor (a tri-axial acceleration sensor) for measuring an acceleration of terminal device 300, a gyroscope for measuring changes in angle or angular velocity of terminal device 300, and a geomagnetic sensor for measuring geomagnetism. Motion sensor 370 provides sensor data output from the sensors to control unit 310. A user is able to operate terminal device 300 by tilting the device forward or back, or to the left or right.

In the present exemplary embodiment, input operation data, coordinate data, and sensor data are all used as data indicative of an input operation performed by a user. Accordingly, in the following description, the three pieces of data will be referred to as “input operation data” collectively, except in a case that it is necessary to make a more specific reference.

Main device 400 is a computer device that manages amounts of a physical activity of a user, and executes a program for measuring an amount of a physical activity, in response to an input operation by a user. Main device 400 also sends shared information to server device 700 according to an input operation by a user or based on a result of execution of a program, and performs image display control of terminal device 300 and display device 500. Shared information herein is information posted by each user to be shared between users. Shared information may include attribute data described later. Main device 400 further provides display data necessary for displaying an image to terminal device 300 and display device 500. Display data is data for causing terminal device 300 and display device 500 to display an image.

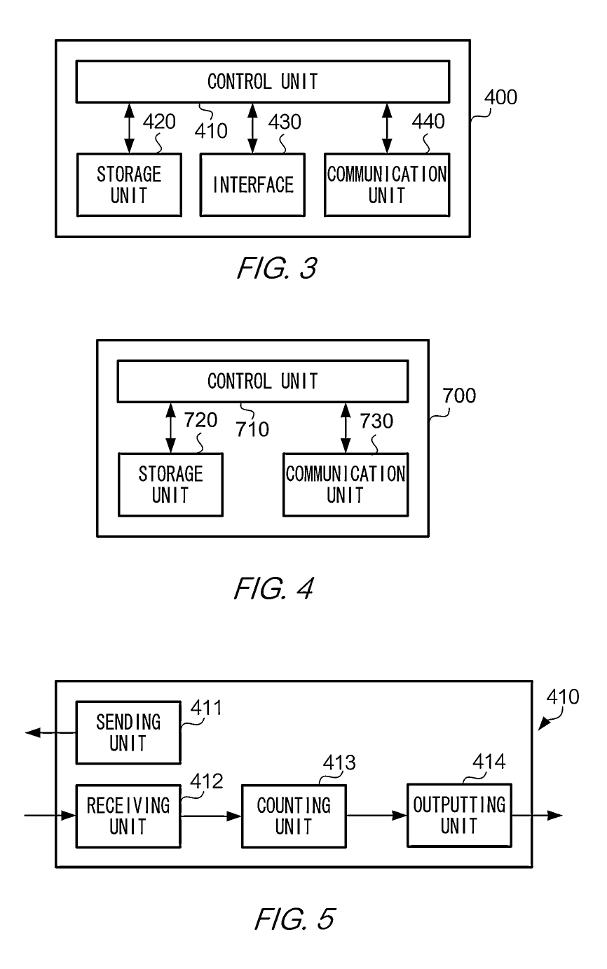

FIG. 3 is a block diagram showing a hardware configuration of main device 400. Main device 400 includes control unit 410, storage unit 420, interface 430, and communication unit 440.

Control unit 410 controls operations of components of main device 400. Control unit 410 includes processors such as a CPU and a GPU (Graphics Processing Unit), and a memory. Control unit 410 executes a predetermined application program (hereinafter referred to as “application”) to measure an amount of a physical activity and to share information. The application has, as main functions, a first function of measuring an amount of a physical activity of a user and managing the information, and a second function of sending the information as shared information to be shared between users. Hereinafter a program for providing the first function will be referred to as “management program,” and a program for providing the second function will be referred to as “information sharing program.”

Storage unit 420 stores data. Storage unit 420 includes a storage medium such as a flash memory or a hard disk. It is to be noted that storage unit 420 may include a data reader/writer to a detachable storage medium such as a memory card or an optical disk.

Interface 430 exchanges data with terminal device 300 and display device 500. In the present exemplary embodiment, interface 430 conducts wireless communication with terminal device 300, and conducts wired communication with display device 500. However, any other communication system may be employed.

Communication unit 440 exchanges data with server device 700 via network 600.

Display device 500 is a stationary display device such as a television. Display device 500 may have a larger display screen than terminal device 300. In the present exemplary embodiment, display device 500 has a larger display screen than terminal device 300. It is to be noted that display device 500 may be a projector that projects an image onto a screen or a wall surface.

Network 600 is a communication network for connecting main device 400 to server device 700. Network 600 is, for example, the Internet. However, network 600 may be another type of communication network.

Server device 700 is a computer device that receives shared information from each user, and sends it to other users. Server device 700 connects to plural main devices 400 (not shown in FIG. 1) via network 600 to exchange shared information with the devices. Server device 700 sorts shared information sent from users according to communities, and sends shared information to users belonging to a corresponding community. A community herein is a group of plural users using information sharing system 10, classified based on a condition such as a common interest. In the present exemplary embodiment, server device 700 may receive from a user, data identifying a community to which the user belongs, identify a community to which the user belongs based on the data, and sends shared information to users belonging to the identified community. However, server device 700 may pre-store data on a community to which each user belongs, and identify a community to which shared information is directed.

FIG. 4 is a block diagram showing a hardware configuration of server device 700. Server device 700 includes control unit 710, storage unit 720, and communication unit 730. Control unit 710 controls operations of components of server device 700. Control unit 710 includes a processor and a memory. Storage unit 720 stores data, which includes a storage medium. Communication unit 730 exchanges data with plural main devices 400 via network 600.

The foregoing is a description of a hardware configuration of information sharing system 10. A user is able to measure and record a performed physical activity using information sharing system 10. In the present exemplary embodiment, information sharing system 10 measures an amount of physical activity by two methods. The first method is a measurement method using activity meter 100. When using this method, a user possesses activity meter 100 or wears activity meter 100 on a part of his/her body. By this method, a user is able to ascertain an amount of physical activity measured when the user possesses activity meter 100. Activity meter 100 is a portable measuring instrument, by which a user is able to measure an amount of physical activity regardless of location (whether indoors or outdoors). By the first method, an amount of physical activity performed on the way to work or school, such as walking, using stairs, or jogging can be measured. For example, if a user wears activity meter 100 and goes outdoors, an amount of physical activity performed when s/he is outdoors is recorded by activity meter 100. After returning home, the user may transfer measurement data recorded in activity meter 100 to main device 400.

The second method is a measurement method using load input device 200, terminal device 300, and main device 400. When using the method, a user performs a physical activity according to instructions displayed on terminal device 300 or display device 500. In such a case, load input device 200 and terminal device 300 are supplementarily used to measure an amount of a physical activity. When the second method is employed, it is assumed that a physical activity is performed at a particular location such as a user's home, unlike a case where the first method is employed. A physical activity performed when the second method is employed may include yoga, muscle training, aerobic exercise, dance, and a game involving a physical activity, and is predetermined in the management program.

Hereinafter, each physical activity, which is performed when the second method is employed, and is predetermined in the management program, will be referred to as an “indoor training exercise.” For each indoor training exercise, a corresponding exercise intensity (MET) is assigned.

Main device 400 may present plural types of indoor training exercises to a user for selection. If a type of indoor training exercise is selected, main device 400 causes terminal device 300 or display device 500 to display an image to prompt the user to perform the indoor training exercise. For example, when “push-ups” are performed as an indoor training exercise, main device 400 causes terminal device 300 or display device 500 to display a video or a message for instructing a user to do “push-ups” with hands on load input device 200, for a given time. After the given time has elapsed, main device 400 determines that the user has finished doing “push-ups.” Subsequently, main device 400 calculates a caloric expenditure based on an exercise intensity assigned to “push-ups,” and the exercise time.

It is to be noted that main device 400 may determine whether a user is actually performing an indoor training exercise based on whether a load is being applied to load input device 200 (namely, whether load data is being provided from load input device 200, which data indicates a load equal to or greater than a predetermined value). If a load indicated by load data is smaller than the predetermined value, main device 400 may determine that a user is not sufficiently performing an indoor training exercise, and subtract a corresponding amount from a caloric expenditure or an exercise time. For some types of indoor training exercises, such a determination may be performed using terminal device 300, instead of load input device 200. In a case of an indoor training exercise performed by a user holding main device 400, main device 400 may determine whether a user is actually performing an indoor training exercise based on the presence, absence, or a value of input operation data provided.

Information sharing system 10 is also capable of managing an amount of a physical activity measured in the foregoing manners, and presenting information necessary for a user. Information sharing system 10, when a user's current weight, a target weight, and a target deadline for achieving the target weight are input, is able to present information on a daily caloric expenditure required to achieve the target weight by the target deadline (target caloric expenditure), and on physical activities required to achieve the target caloric expenditure.

Further, a user is able to share information on a measured and recorded physical activity with other users. A user who wishes to do so is able to share with other users information on a caloric expenditure, a target weight, or a type of indoor training exercise performed. In the present exemplary embodiment, a user selects a community to which s/he belongs, and shares posted information with users belonging to the community. Such a function is provided by the information sharing program.

FIG. 5 is a block diagram showing a functional configuration provided by the information sharing program. When the information sharing program is executed by control unit 410 of main device 400, functions of sending unit 411, receiving unit 412, counting unit 413, and outputting unit 414 are provided.

Sending unit 411 sends shared information. Sending unit 411 sends user's shared information via communication unit 440 according to an input operation by a user or depending on a status of execution of the application. In the present exemplary embodiment, sending unit 411 may send shared information at a time that a user indicates by an input operation, or may automatically (namely, without a user's explicit instruction) send shared information at a predetermined time such as when an indoor training exercise is finished.

Sending unit 411 also sends data dependent on the application as shared information. Data dependent on the application herein refers to data generated or modified when the application is running. For example, data on a history of a performed physical activity, such as a caloric expenditure, or a type of indoor training exercise performed is an example of data dependent on the application.

Receiving unit 412 receives shared information. Specifically, receiving unit 412 receives shared information via communication unit 440, which has been sent from another user belonging to a community to which a user of main device 400 belongs. In the present exemplary embodiment, receiving unit 412 sets an upper limit on a number of items of shared information that can be received. In the present exemplary embodiment, it is assumed that the upper limit is fifty. Receiving unit 412 may preferentially receive shared information from another user, who meets a predetermined condition.

Counting unit 413 is a unit for performing counting based on attribute information included in shared information. Attribute information herein refers to information on attributes or characteristics of a user of information sharing system 10. Attribute information may include not only data on a name, age, sex, or weight of a user, but also data on a history of physical activities. A name of a user may be ID (Identification Data) such as numbers, or a nickname, instead of a real name.

Outputting unit 414 is a unit for outputting information generated based on shared information received by receiving unit 412. Information output by outputting unit 414 includes at least display data for displaying an image on terminal device 300 or display device 500. The information may also include audio data for reproducing background music or a sound effect.

### (2) Method for Utilization

A user of information sharing system 10 can record his/her current weight and a caloric expenditure, and also to receive a service by which s/he is able to interact with other users using the information recorded (hereinafter referred to as “information sharing service”). The information sharing service is, so to speak, a social networking service (SNS) provided to users using a same application. A user is able not only to browse shared information sent from another user, but also to establish a relationship with another user by following him/her or registering him/her as a friend. “Following” herein refers to an action made by a user to track actions of another user. Following does not require consent of the other user. On the other hand, a relationship of “friend” herein is established with consent of the other user. A user may send a message to another user.

To use the information sharing service to interact with other users, a user of information sharing system 10 is required not only to perform a physical activity, but also to perform actions of “registration of information,” “posting,” and “browsing of screens.” The actions will be described below, using a concrete example.

### (Registration of Information)

A user registers information necessary to use the information sharing service, for example, when s/he uses the application for the first time. Information to be registered may be a name, age, gender, height, weight, target weight, and target deadline. The information is input by operating terminal device 300. A weight may be input using load input device 200. Main device 400 stores data input by a user in storage unit 420.

A user also registers a community to which s/he belongs. A community is formed according to a user's preference or purpose. For example, communities such as a “community for yoga enthusiasts,” a “community for jogging enthusiasts,” and a “community for people who want to lose weight” may be formed. Communities may be pre-formed by a provider of the information sharing service. However, a new community may be formed by a user. A user who does not wish to share information with other users may opt not to register a community.

The application according to the present exemplary embodiment may support a multi-account feature. Specifically, main device 400 may differentiate plural users such as family members, and create an account for each user. In this case, main device 400 may identify a user through a login procedure performed at the start of the application. Also, main device 400 may, for each user, accept registration of information such as a name, and record it.

### (Posting)

A user is able to measure an amount of a physical activity using the first method or the second method. Main device 400 records data on the measured amount of physical activity, and sends shared information to server device 700 at an appropriate time. For example, when an indoor training exercise has been completed, main device 400 sends shared information reporting the indoor training exercise as a most recently performed physical activity. Alternatively, when main device 400 has retrieved measurement data from activity meter 100, main device 400 may send shared information.

When sending shared information, main device 400 may also send attribute information of a user. For example, main device 400 may send data on a history of physical activities performed; namely, data on types of indoor training previously performed and data on caloric expenditures. Also, main device 400 identifies a community to which a user belongs from among plural communities, and sends data indicative of the identified community to server device 700.

Main device 400 may include a message in shared information. A message herein is, for example, that Taro performed “Salute to the Sun,” in a case where a user named “Taro” has performed a yoga exercise “Salute to the Sun.” A message may be created by adding a name and a type of performed physical activity to a message template. Alternatively, a message may be manually input by a user.

Also, when a particular event has occurred in the application such as when a user has reached his/her target weight, main device 400 may include information indicative of the event in shared information. Alternatively, when a user has reached his/her target weight, main device 400 may replace the aforementioned message with a special message. A special message may be a template message stating that Taro has reached a target weight.

### (Browsing of Screens)

Main device 400 receives shared information, which has been sent from another user, from server device 700 according to an input operation by a user or an appropriate time. To receive shared information, main device 400 sends a request to send shared information (hereinafter referred to as “transmission request”) to server device 700. Main device 400 may send a transmission request together with shared information.

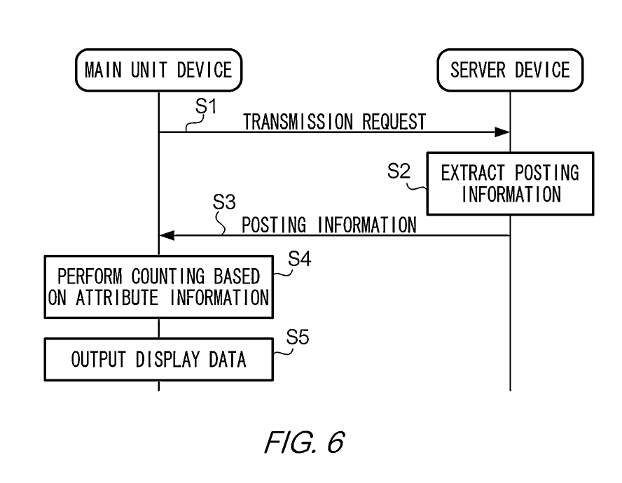

FIG. 6 is a sequence chart showing operations of main device 400 and server device 700, which operations are carried out when main device 400 receives shared information. By the operations, main device 400 initially sends a transmission request to server device 700 (step S1). In the transmission request, conditions relating to shared information to be sent are described. A condition is, for example, the number of items of shared information to be sent. In a case where there is another user whose shared information should be preferentially sent, main device 400 may describe, in the transmission request, conditions relating to another user whose shared information should be preferentially sent.

Another user whose shared information should be preferentially sent is, for example, at least one of the organizers of a community to which the user belongs, a friend of the user, another user followed by the user, and another user whose shared information has previously been received. To receive shared information sent from another user whose shared information has previously been received, main device 400 may record other users in a list, whose shared information has been previously received. In the list, a score may be kept for each user. For example, plus three points may be given to a user whose shared information has been received for the first time, plus five points may be given to a user whose shared information has been previously received, and minus one point may be given to a user whose shared information has been received one or more times, but has not been received at a subsequent time of receiving shared information. Shared information may be received from a predetermined number of users having a high score.

When server device 700 receives the transmission request from main device 400, server device 700 extracts shared information sent from other users who belong to a community to which the user who has sent the transmission request belongs (step S2). In a case where there is no user whose shared information should be preferentially sent, server device 700 extracts a predetermined number of items of shared information, whose posting date and time is delayed. On the other hand, in a case where there is a user whose shared information should be preferentially sent, main device 400 extracts shared information sent from the user within a certain period of time (for example, one day or one week) from a present date and time. Alternatively, server device 700 may extract most recent shared information sent from the user regardless of the posting date and time. Server device 700 sends the extracted shared information to main device 400 (step S3).

It is to be noted that server device 700 may send shared information in response to the transmission request, without making a selection of shared information. Also, selection of shared information may be made by server device 700, main device 400, or both. For example, main device 400 may send a transmission request, together with data indicative of a community to which the user belongs, and server device 700 may send, in response to the transmission request, shared information sent from another user belonging to the community to main device 400. Main device 400 that has received the shared information may extract shared information whose posting date and time is delayed, or shared information sent from another user whose shared information should be preferentially received.

When main device 400 receives the shared information sent from server device 700, main device 400 performs counting based on attribute information (step S4). For example, main device 400 may count users who have sent the shared information on a gender basis to calculate a male to female ratio. Alternatively, main device 400 may count physical activities performed by the users on a type basis. Main device 400 may perform counting based on other attributes.

Lastly, main device 400 outputs display data according to the received shared information to terminal device 300 or display device 500 (step S5). Alternatively, main device 400 may output the display data to both terminal device 300 and display device 500. In the latter case, terminal device 300 and display device 500 may display a same image or a different image.

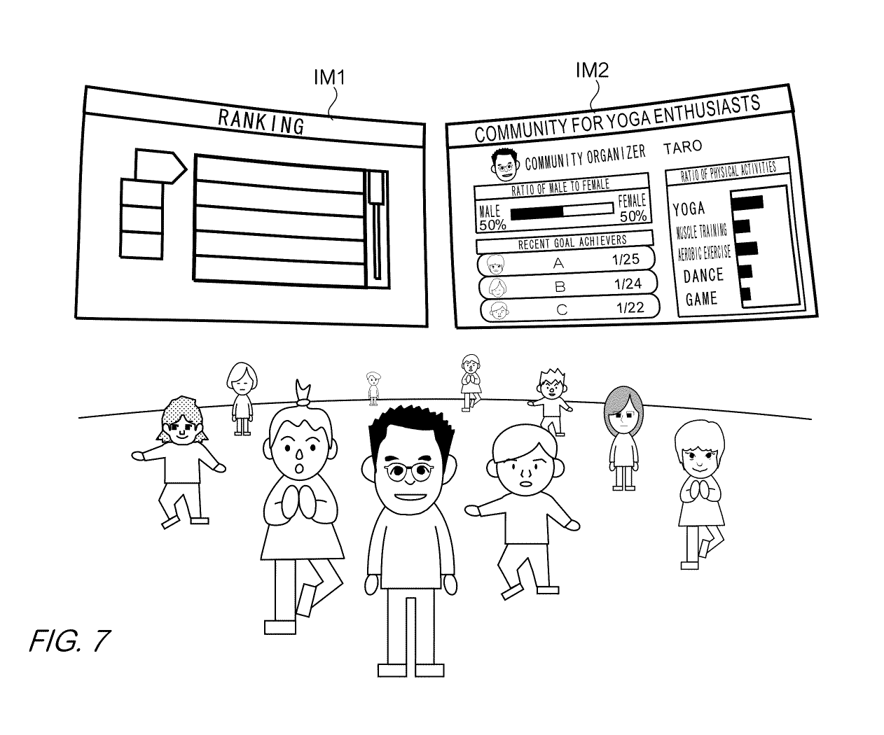

FIGS. 7 to 9 are diagrams each showing an example screen displayed in terminal device 300 or display device 500. FIG. 7 is a diagram showing an example of a menu screen. A menu screen herein is a screen from which a user makes a selection to go to another screen. A menu screen shows images IM1 and IM2 each showing another screen to which a user goes from the menu screen. A menu screen also shows avatars, which are alter egos of users. An avatar of the user of main device 400 and avatars of other users who sent the shared information received from server device 700 are shown.

Data for specifying an avatar image (facial expression, clothing, body shape, etc.) may be included in attribute information. For example, a body shape of an avatar may be determined based on data on a height and a weight included in attribute information. A facial expression or clothing of an avatar may be designed by a user, or may be determined depending on a caloric expenditure or a physical activity performed. Also, main device 400 may display an animation of an avatar, which performs an action according to a physical activity most recently performed by a user (for example, an action similar to the physical activity).

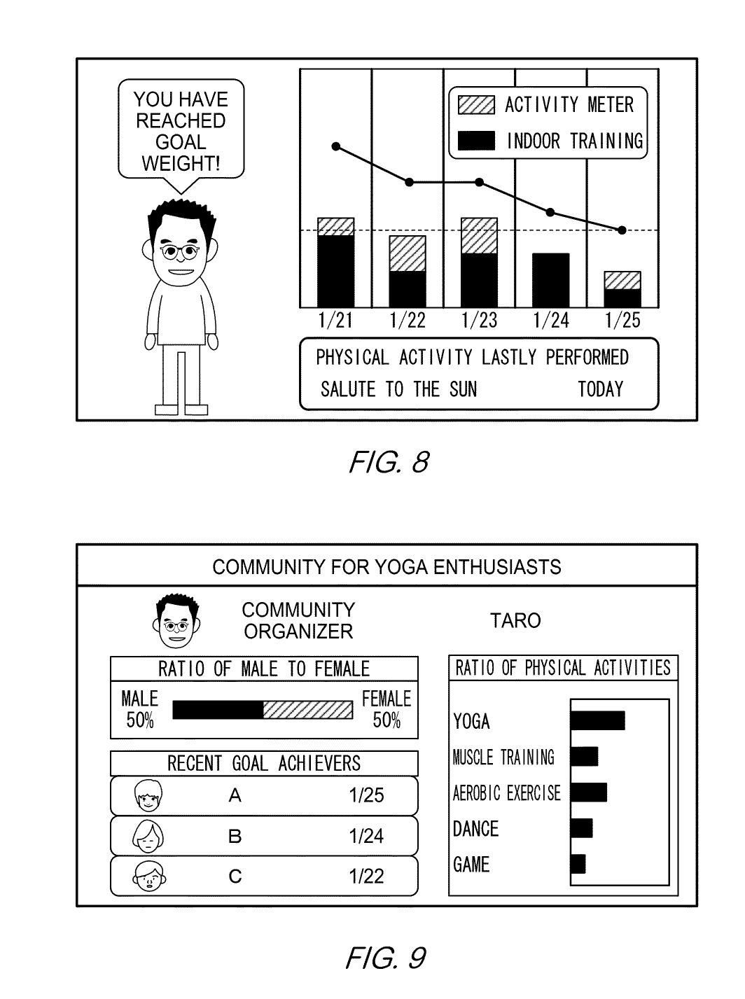

FIG. 8 is a diagram showing an example screen showing detailed information of a user (user detail screen). Main device 400, for example, when the menu screen shown in FIG. 7 is displayed, and an avatar is selected by a user, displays a user detail screen corresponding to the selected avatar. When doing so, main device 400 displays the user detail screen based on shared information sent from a user corresponding to the selected avatar.

On a user detail screen, a message from a user, a graph of the caloric expenditure and the weight, and a physical activity performed by the user are shown. In the graph of the caloric expenditure, a caloric expenditure measured by activity meter 100 and a caloric expenditure measured when an indoor training exercise is performed may be shown separately. A physical activity performed by the user may not be a physical activity most recently performed by the user. Instead, a predetermined number of physical activities recently performed by the user may be shown. By browsing a user detail screen, a user can ascertain what types of physical activity other users perform. It is to be noted that weight data of a user, who wishes others not to become aware of it, may be shown in such a way that a concrete numerical value cannot be known. Alternatively, whether to allow weight data to be shown may be selected by the user.

FIG. 9 is a diagram showing an example screen showing detailed information of a community to which a user belongs (community detail screen). The screen is displayed when a user selects image IM2 shown in FIG. 7. A community detail screen shows the name of a community, the organizer, a male to female ratio, and a ratio of physical activities performed. On the example screen, a list of users who have achieved their target weights is shown.

As described in the foregoing, according to the present exemplary embodiment, a user can ascertain attributes and specific activities of other users whose shared information has been received. In the present exemplary embodiment, where shared information sent from a user belonging to a community to which the user belongs is selectively sent, it is easier to obtain information from users having a preference or purpose similar to that of the user, as compared with a case where shared information of users using the application used by the user is simply sent. Especially, in the case of the application according to the present exemplary embodiment, whereby a variety of physical activities can be performed, users' purposes of using the application may vary considerably, even though the same application is used. However, in the present exemplary embodiment where shared information is selectively shared between users belonging to a community, it is easier to share information between users having a similar purpose. Also, according to information sharing system 10, a user may follow or become friends with another user by referring to shared information. Accordingly, communication between users is promoted.

In addition, according to information sharing system 10, shared information from a user, whose shared information has previously been received, may be preferentially received. In such a case, it is likely that a user sees another user who has been seen previously. As a result, a user is likely to have a sense of affinity with another user, and thus is likely to be motivated to follow the user or register the user as a friend. Also, shared information from a user who frequently posts information is likely to be received by other users; therefore, it is easy to have an opportunity to interact with a user actively using the information sharing service.

### MODIFICATIONS

The above exemplary embodiment is an example of an embodiment of the present technique. The present technique may be implemented in embodiments shown by the following modifications, other than the above exemplary embodiment. The following modifications may be combined with each other.

### Modification 1

In the above exemplary embodiment, physical activities (indoor training exercises) such as yoga, muscle training, aerobic exercise, and dance are considered to have a competitive element. Accordingly, the physical activities may be referred to as examples of different games. Similarly, a physical activity measured by activity meter 100 may be considered to be a game.

The present technique can be applied to an application for providing a game other than the physical activities. In the case of an action game, stages of the game may be considered to be examples of different games. In the case of a role-playing game, scenes (field, town, dungeon, etc.) of the game may be considered to be examples of different games. The “different games” herein may refer to elements of a game provided by an application. A game play history may include a screenshot of a game screen, or data for recreating performance of a user in a game (namely, ghost data). In the present technique, shared information may be sent when a game ends, or when a predetermined event occurs in a game. An application according to the present technique may not relate to a game.

### Modification 2

In the above exemplary embodiment, it is assumed that there are plural communities for a single application. However, there may be only a single community for a single application. In that case, if some users belong to the community and others do not, information is shared between particular users from among all users of the application.

### Modification 3

In the above exemplary embodiment, the management program and the information sharing program are included in a single application. However, the two programs are not inevitably linked to each other. The two programs may be included in different applications.

### Modification 4

In the present technique, attribute information does not have to be included in shared information. The present technique may be used without attribute information (in other words, in an embodiment where output information does not depend on attribute information). In this case, a function of counting unit 413 may be omitted.

### Modification 5

In an embodiment according to the present technique, a part of the functions provided in main device 400 may be provided in server device 700. For example, server device 700 may include a function of counting unit 413. In that case, server device 700 may perform counting based on attribute information, and send data indicative of the result of the counting to main device 400. When doing so, server device 700 may perform the counting based on not only attribution information of users whose shared information is to be sent, but also attribute information of other users who belong to the same community as the users belong to.

### Modification 6

In an embodiment according to the present technique, the functional configuration (sending unit 411, receiving unit 412, counting unit 413, and outputting unit 414 shown in FIG. 5), which may be provided in an information-processing device, may be provided by single or plural items of software. The program according to the technique may be executed in a single device or plural devices. The program may be provided to an information-processing device in the form of a storage medium such as an optical disk or a semiconductor memory. Alternatively, the program may be downloaded to an information-processing device via a network such as the Internet.

What is claimed is:

1. An information-processing device, comprising:
a sending unit that sends data dependent on an application as shared information, the shared information being associated with a community to which a user of the information-processing device belongs from among one or more communities relevant to the application;
a receiving unit that receives shared information sent from another user, who belongs to the community to which the user of the information-processing device belongs; and
an outputting unit that outputs information generated based on the shared information received by the receiving unit.

2. The information-processing device according to claim 1, wherein:
plural communities are provided for the application; and
the sending unit identifies the community to which the user of the information-processing device belongs from among the plural communities, and sends the shared information in such a manner that the shared information is associated with the identified community.

3. The information-processing device according to claim 1, wherein the application includes a function by which different games are played.

4. The information-processing device according to claim 1, the shared information includes a history of execution of the application.

5. The information-processing device according to claim 1, wherein the sending of the shared information by the sending unit is triggered by occurrence of a predetermined event.

6. The information-processing device according to claim 5, wherein the sending of the shared information by the sending unit is triggered by termination of the application.

7. The information-processing device according to claim 1, wherein the receiving unit preferentially receives shared information from another user meeting a predetermined condition.

8. The information-processing device according to claim 7, wherein the receiving unit preferentially receives shared information from another user whose shared information has previously been received.

9. The information-processing device according to claim 1, wherein:
the shared information received by the receiving unit includes attribute information of the other user; and
the outputting unit outputs information indicative of a result of counting based on the attribute information included in the shared information received by the receiving unit.

10. The information-processing device according to claim 9, further comprising a counting unit that performs counting based on the attribute information included in the shared information received by the receiving unit, wherein the outputting unit outputs information indicative of a result of the counting by the counting unit.

11. A non-transitory storage medium storing a program for causing a computer to execute the steps of:
sending data dependent on an application as shared information, the shared information being associated with a community to which a user of the computer belongs from among one or more communities relevant to the application;
receiving shared information sent from another user, who belongs to the community to which the user of the computer belongs; and
outputting information generated based on the received shared information.

12. An information sharing system, comprising:
a plurality of information-processing devices; and
a server device, wherein each of the plurality of information-processing devices comprises:
a sending unit that sends data dependent on an application to the server device as shared information, the shared information being associated with a community to which a user of the information-processing device belongs from among one or more communities relevant to the application;
a receiving unit that receives, from the server device, shared information sent from another user, who belongs to the community to which the user of the information-processing device belongs; and
an outputting unit that outputs information generated based on the shared information received by the receiving unit.

13. An information sharing method, comprising:
obtaining by a server device, from each of a plurality of information-processing devices, data dependent on an application as shared information, the shared information being associated with a community to which a user of the information-processing device belongs from among one or more communities relevant to the application;
in response to a request from a user, sending, by the server device, shared information sent from another user belonging to a community to which the user belongs, to an information-processing device of the user who has made the request; and
outputting information generated based on the shared information received from the server device.
